(19) United States
(12) Patent Application Publication
(10) Pub. No.: US 2019/0153636 A1
(43) Pub. Date: May 23, 2019

(54) TEXTILE REINFORCEMENT SUITABLE FOR BEING USED IN A METHOD FOR IMPREGNATION BY A THERMOPLASTIC RESIN

(71) Applicant: CHOMARAT TEXTILES INDUSTRIES, LE CHEYLARD (FR)

(72) Inventor: Jerome Maupetit, Duniere Sur Eyrieux (FR)

(21) Appl. No.: 16/315,079

(22) PCT Filed: Jul. 6, 2017
(86) PCT No.: PCT/FR2017/051851

§ 371 Date: Jan. 3, 2019

(30) Foreign Application Priority Data
Jul. 8, 2016 (FR) 1656615

(51) Int. Cl. D03D 25/00; B32B 5/02; B32B 5/26; B32B 5/10

(52) U.S. Cl. CPC D03D 25/00; B32B 5/022; B32B 5/024; B32B 2305/08; B32B 5/10; B32B 2262/02; B32B 5/26

(57) ABSTRACT

The invention relates to a textile reinforcement suitable for being used in a method for impregnation by a thermoplastic impregnation resin, with a view to producing composite parts, including at least one set of substantially parallel high-tenacity yarns, and a sewing yarn sewn through the one or more sets, characterized in that the sewing yarn includes filaments which have a melting temperature higher than the melting temperature of said thermoplastic impregnation resin, and filaments made from a thermoplastic material, which can be mixed into the impregnation resin, and which have a melting temperature lower than the implementation temperature of said thermoplastic impregnation resin.

### CROSS REFERENCE TO RELATED APPLICATIONS

This application is a national stage application, filed under 35 U.S.C. § 371, of International Application No. PCT/FR2017/051851, filed Jul. 6, 2017, which application claims priority to French Application No. 1656615, filed Jul. 8, 2016, the contents of both of which as are hereby incorporated by reference in their entirety.

### BACKGROUND

### Technical Field

The invention relates to the field of the textile industry, and more specifically that of technical textiles used for the production of composite parts. Such parts are manufactured by combining one or more textile layers with a generally polymeric matrix that impregnates the textile layers. Depending on the desired properties relative to mechanics and temperature, different types of resin can be employed, and typically thermosetting resins or thermoplastic resins.

More specifically, the present invention concerns textile reinforcements intended to be impregnated with a thermoplastic resin. More particularly, it concerns the use of a particular sewing yarn used for joining different plies of the reinforcement.

### Related Art

In general, the manufacture of composite parts comprises a step of placing a fibrous reinforcement in contact with a polymeric matrix and a molding step by which this assembly is shaped to adopt the final desired shape for the composite part. Placing the impregnation resin in contact with the textile reinforcement can be done either after the mold is closed, for example in the so-called RTM (Resin Transfer Molding) methods, or prior to closing the mold by spraying or direct deposit of the impregnation resin onto the textile layers. Thus, closing the mold causes an increase in pressure, which enables the different reinforcement plies to be impregnated in a direction perpendicular to the principal plane of the reinforcement.

In practice, textile reinforcements used can be of different natures, depending on the type of application. Thus, it can involve woven reinforcements, in which the warp and weft yarns ensure a reinforcing action in their preferred direction. It can also involve reinforcements formed by combining a plurality of plies or sets of yarns which are completely parallel, and which are in different directions from one ply to the next. These plies are joined together after superimposition by placing a sewing yarn through the set of layers to be joined. Unlike woven fabrics, these plies have yarns that are as straight as possible, and therefore uncrimped, conventionally known as NCF or Non-Crimped Fabric.

Different technical difficulties can arise in the sequence of steps leading to the production of the composite part. First, the textile is cut into the desired shape of the final part. At that time, the areas of cut are subject to risks of fraying, particularly when they are at a small angle relative to that of the cut yarns. Indeed, in particular when the yarns employed are strands of parallel filaments, or rovings, the cut filaments are only weakly held, and can easily be separated from the rest of the textile to which they are held only by friction with the sewing yarn.

Second, the cut textile is then placed in the mold, which often has a three-dimensional shape. Retaining the three-dimensional shape of the textile draped in the mold, or retaining the shape of the same preformed textile on an intermediate template, poses problems in that the textile is relatively flexible and is not fixed in position. The solution described in the document EP 1 781 445, which consists in using a textile having a repositionable adhesive layer, is not completely satisfactory. Indeed, the added adhesive constitutes additional material that is not necessarily compatible with the resin that will subsequently be used for the impregnation. Furthermore, the presence of this adhesive interferes with or even prevents the circulation of the impregnation resin at the face where it is present.

Another difficulty encountered occurs during molding, when the impregnation resin is placed in contact with the textile. Indeed, to ensure satisfactory circulation the impregnation resin must be raised to a high temperature, on the order of 120 to 180° C. for SMC type thermocompression methods, and on the order of 250° C. and more often close to 300° C. for methods using polyamide (PA) type thermoplastic matrices, and even 400° C. for high performance polymers. At that temperature, the yarns used to sew different textile layers together are softened or even melted. Under these conditions, the flow of impregnation resin around and inside the textile reinforcement causes the deformation thereof, and the displacement of some yarns relative to the others. This results in a lack of homogeneity of the textile reinforcement within the composite part. This problem is all the more significant when attempting to obtain a composite part with high fiber content. Indeed, in this case the pressures exerted on the reinforcement are very high in order to strongly squeeze out the reinforcement, with high stresses on the threads and increased risk of deformation of the reinforcement. The use of a temperature-resistant sewing yarn, particularly of glass, is not really satisfactory because this type of yarn is relatively fragile, and during sewing operations it could break, in addition to the fact that it would excessively wear the sewing heads. The use of less abrasive yarns such as those based on polyphenylene sulfide (PPS) or polyetheretherketone (PEEK) would make it possible to limit these wear phenomena, but provide no solution for the problem of fraying and of preforming. Moreover, the thermal resistance of such yarns is limited.

The document WO 02/04725 describes a textile reinforcement comprising sewing yarns that are produced from fusible yarns, which after melting therefore no longer provide mechanical strength to the reinforcement. The document FR 2 594 858 describes a textile reinforcement including sewing yarns formed of a core of glass filaments sheathed with a layer of polyamide. Unfortunately such a solution remains limited in processability for the sewing operations. Indeed, the coating in the form of a sheath around the core results in a rigidity of the yarn that is too great for optimal utilization as sewing yarn. Yarn that is too rigid cannot follow the angles of deviation involved in the sewing method (particularly passing through needles). The sewing machine speed must be lowered in this case. Moreover, any defect in coating will generate a point of weakness and breakage of the yarn in the sewing process.

### DETAILED DESCRIPTION OF VARIOUS EMBODIMENTS

Therefore, the invention seeks to provide a reinforcement that mitigates the various disadvantages mentioned above, and which has good properties relative to fraying, which enables preforms to be produced simply, and above all which has good mechanical cohesion during molding operations at high temperature.

The invention therefore concerns a textile reinforcement suitable for use in a method of impregnation by a thermoplastic impregnation resin, with a view to producing composite parts by exposure of the reinforcement to the said resin at a temperature for implementation of the method well above the melting temperature of the impregnation resin. The said textile reinforcement comprises at least one set of substantially parallel high-tenacity yarns, typically made of glass, carbon or similar material. The said reinforcement also comprises a yarn sewn through the said set or sets of yarns to ensure the cohesion thereof.

According to the invention, the said sewing yarn comprises a group of filaments having a melting temperature higher than the application temperature of the said thermoplastic impregnation resin, and a group of filaments produced from a thermoplastic material, miscible or even soluble in the impregnation resin, and having a melting temperature lower than the application temperature of the said thermoplastic impregnation resin. These two groups of filaments of different natures are assembled by pairing, twisting or wrapping.

In other words, the invention consists of achieving the sewing of the reinforcement with a yarn including a portion resistant to the temperatures observed during the molding operations. Thus, the mechanical strength of the reinforcement is preserved during the molding, and when the resin flows transversely through the reinforcement. Complementarily, the complementary portion of the sewing yarn is heat fusible and compatible with the impregnation resin so that it does not create areas of fragility in the composite part, since this portion of the sewing yarn is embedded in the impregnation resin of the reinforcement. Moreover, because this portion of the sewing yarn is melted during the molding operation, the position it holds in the hole formed by the sewing yarn is reduced, and it allows a rearrangement of the filaments of the reinforcement in a more rectilinear configuration.

The said thermoplastic portion facilitates the sewing operations because it allows limited friction between the sewing yarn and the sewing head.

The said heat-fusible portion has other advantageous effects, since it can easily be softened or melted even before molding, thus ensuring adhesion of the yarns and filaments with which it is in contact. In particular, this makes it possible to secure the said filaments and to limit the risks of fraying at the cutting regions. The said partial adhesion of the reinforcement at the sewing yarns can also be advantageous to ensure retaining the shape of the reinforcement when it is disposed in the mold, placed on a preform.

In practice, it is possible to produce the said sewing yarn in different ways. Pairing refers to when the filaments of two different types are assembled before going through a throwing operation to obtain yarns or strands firmly combining the two types of filaments. Twisting refers to when the groups of filaments each undergo throwing in order to obtain homogeneous strands, which are then assembled by twisting to form intertwined helices. Wrapping refers to when the two strands of different natures are assembled, one of which strands is rolled around the other, called the core yarn, generally substantially straight, around which the wrapper yarn forms a helix.

The final yarn count of the assembly of the said filaments should be compatible with the utilization of said assembly as sewing yarn. The final yarn count can advantageously be between 20 and 300 dtex.

In practice, the said sewing yarn can be used on different types of reinforcements. Thus, this reinforcement can be of the NCF type with a single layer in which there is no crimping of the yarns. Such a reinforcement, unidirectional, can be associated with a support layer formed by a fibrous material, the fibers whereof are not parallel to those of the reinforcement layer. The said support layer can be non-woven, such as lightweight web, or a set of parallel yarns disposed parallel and spaced apart from each other, to form a weave that is also light, enabling the sewing yarn to be held. It is also possible to achieve the cohesion of the layer of reinforcement yarns solely by the sewing yarn with sewing produced by a knitting stitch. Of course, the reinforcement can comprise a plurality of layers each formed by a set of high-tenacity yarns that are substantially parallel, and in which the orientations of the yarns of the two adjacent layers are distinct in order to form a multi-axial reinforcement. The characteristic sewing yarn then provides a joining of the different plies to each other, which is necessary for handling, and more generally for the mechanical strength of the reinforcement.

The said sewing yarn can also be used for fabrics in which the sets of yarns are woven together. In this case, while the weaving intrinsically ensures a certain mechanical cohesion of the reinforcement, the use of the characteristic sewing yarn reinforces said cohesion during the flow of resin, but in particular makes it possible to benefit from the reduction of risks of fraying, and especially the possibility of retaining shape after being placed on a preform.

In one particular embodiment of the invention, the sewing yarn comprises at least two distinct groups of filaments produced from a thermoplastic material, miscible in the impregnation resin, and having a melting temperature lower than the melting temperature of the said thermal plastic impregnation resin. Each group of filaments is wrapped around the group of filaments having a melting temperature greater than the melting temperature of the said thermoplastic impregnation resin, and two of the said groups of filaments are wrapped in opposite directions.

In other words, the sewing yarn comprises a core yarn that has a resistance to the temperature conditions observed during impregnation, which is covered by two (or more) yarns wrapped in opposite directions, in such a way that the outer wrapper yarn somewhat locks the inner wrapper yarn, which limits the risks of raveling of said inner yarn when the sewing yarn is subjected to mechanical stresses during the operations of sewing through the reinforcement.

Advantageously in practice, the distinct groups of filaments produced from a thermoplastic material, miscible in the impregnation resin, have different melting temperatures. In other words, a first exposure to heat enables the softening of the wrapper yarn of lower glass transition temperature, in order to secure the other wrapper yarn, and thus make the assembly more resistant to raveling during sewing.

Thermal activation can also occur after sewing to secure the yarns of the reinforcement and ensure resistance to fraying of the reinforcement. In that case, the yarn of lower melting temperature will preferably be positioned at the outside.

Complementarily, the thermal activation of the other wrapper yarn can enable the reinforcement to be secured when it is in three-dimensional form.

Depending on the applications, the sewing can take place either during the manufacture of the reinforcement by traditional sewing in the plane of the reinforcement, or after forming the reinforcement on a preform by three-dimensional sewing. The characteristic sewing yarn can be used alone, and on its own ensure improvement of retention of the reinforcement. The said retention can also be supplemented by the use of other traditional sewing yarns.

In general, the filaments of the temperature-resistant sewing yarn are made of a material that can be chosen from the group preferably comprising glass, but also aramid, carbon, basalt, quartz, liquid crystal polymers and cotton. The yarn count of the yarn is chosen in accordance with the applications. It can be very low to limit the impact of said yarn in the final composite, or higher if there is a greater need for mechanical strength.

Advantageously, the material of which the miscible filaments are composed can be chosen from the same chemical family as the impregnation resin. In particular therefore, it can involve a polyamide resin, used in order to be compatible with the polyamide 6 (PA6) or 6.6 (PA66) resin used for the impregnation of the reinforcements. It can also involve an acrylic resin used in order to be compatible with an impregnation resin of methyl methacrylate or acrylonitrile butadiene styrene (ABS). For impregnation applications using polyphenylene sulfide (PPS) type resin, preferably a yarn material of PPS resin will be chosen. For impregnation applications using polyaryletherketones (PAEK), preferably a yarn material of PAEK resin will be chosen, such as the polyetheretherketones (PEEK) or polyetherketoneketones (PEKK), and for example more particularly a PEKK resin the melting point of which will be lower than that of the PEEK impregnation resin.

The coating resin forming the heat-fusible portion of the sewing yarn advantageously has a sufficiently low softening point, typically at least 20° C. lower than the melting temperature of the injected polymer, to enable the reinforcement to be secured at low temperature and to be melted during the injection procedure. For amorphous materials that do not have a melting temperature per se, for the purposes of the present patent the melting temperature will be similar to the glass transition temperature, beyond which the mechanical properties of the material become greatly reduced.

A first exemplary embodiment of a reinforcement according to the invention is as follows. The reinforcement is produced from fabric composed of carbon fibers with a yarn count of 12 K, corresponding to a surface mass on the order of 300 g/m², like the product marketed under the reference “C-WEAVE 300T 12K HS” by the Applicant. The said fabric receives a sewing yarn, sewn with a chain stitch or knitting stitch at a pitch of 4 mm. The sewing yarn has a core yarn that is a glass yarn with a yarn count of 5.5 tex. The said core yarn has a melting temperature of more than 800° C. It is covered with a first wrapper yarn of polyamide 66, of 44 dtex yarn count, at 200 turns/meter in the Z (or S) direction, which has a melting point on the order of 260° C., and which has undergone a texturizing treatment. The yarn receives a second identical wrapper yarn, wrapped in equal quantity, but in the S (or respectively Z) direction. Such a reinforcement is particularly suited for producing composite parts impregnated with a PA6 or PA66 resin. Production of plates by impregnation of the said fabrics with a PA66 resin at 300° C. shows the benefit of this sewing in terms of retention of the orientation of the fibers when placed under pressure at high temperature.

A second exemplary embodiment of a reinforcement according to the invention is as follows: The reinforcement is produced from NCF and is composed of two plies of carbon fibers oriented at +45° and −45°, corresponding to a surface mass on the order of 150 g/m², as marketed by the Applicant under the reference “C-PLY BX150.” The sewing yarn used is similar to the one in the preceding example, with a core formed by a glass yarn of 55 dtex. It is covered with a first wrapper yarn of polyamide 66, of 44 dtex, at 200 turns/meter in the Z (or S) direction, which has a melting point on the order of 260° C., and which has undergone a texturizing treatment. The yarn receives a second wrapper yarn of polyamide 11, of 44 dtex yarn count, at 200 turns/meter in the Z (or S) direction, which has a melting point on the order of 190° C., and which has undergone a texturizing treatment. The second yarn is wrapped with a number of turns equal to the first, but in the S (or respectively Z) direction, to produce a total yarn count of the sewing yarn on the order of 150 dtex. Such a reinforcement is particularly suited for producing composite parts impregnated with a PA6 or PA66 resin.

The reactivation of the sewn product at 210° C. enables the fibers to be locked and to give an anti-fraying property to the sewn reinforcement, so that during cutting of the reinforcement, the fibers are kept together. Preforming tests of the said reinforcement by stacking 3 plies and reactivation at 210° C. show that the characteristic sewing yarn allows the plies to be bonded together.

A third exemplary embodiment of a reinforcement according to the invention is as follows: The reinforcement is produced from NCF and is composed of two plies of carbon fibers at +45° and −45°, corresponding to a surface mass on the order of 150 g/m², as marketed by the Applicant under the reference “C-PLY BX150.” The sewing yarn used is of a similar structure to the one in the preceding example, with a core formed from a multi-filament glass yarn of 28 dtex. It is covered with a first wrapper yarn of monofilament polyetheretherketone (PEEK), of 50 dtex yarn count, at 200 turns/meter in the Z (or S) direction, which has a melting point on the order of 340° C. The yarn receives a second wrapper yarn of monofilament PEEK, of 50 dtex yarn count, which has a melting point on the order of 340° C. The said second yarn is wrapped with a number of turns equal to the first, but in the S (or respectively Z) direction, to produce a total yarn count of the sewing yarn on the order of 130 dtex. Such a reinforcement is particularly suited for producing composite parts impregnated with a PEEK resin.

A fourth exemplary embodiment of a reinforcement according to the invention is as follows: The reinforcement is produced from NCF and is composed of glass fiber at +45° and −45°, corresponding to a surface mass on the order of 600 g/m², as marketed by the Applicant under the reference “G-PLY BX600.” The sewing yarn used is formed of a core formed by a multifilament glass yarn of 55 dtex. It is twisted with a texturized multifilament PPS yarn of 78 dtex, at 200 turns/meter in the Z or S direction. The PPS yarn has a melting point on the order of 280° C. The total yarn count of the sewing yarn is on the order of 130 dtex. Such a reinforcement is particularly suited for producing composite parts impregnated with a PPS resin.

It is clear from the foregoing that the reinforcement according to the invention can be used in different particular ways, such as:
semi-finished product for manufacturing organo sheets, formed by stacking multiple layers of the same reinforcement, multiple layers of thermoplastic films;
semi-finished product in the manufacture of thermoplastic pre-impregnates. The impregnation resin is then deposited on or in the reinforcement by a powder or impregnation procedure;
semi-finished product in the manufacture of pre-impregnates intended to be used for SMC type molding,
semi-finished product in the manufacture of pre-impregnates or profiled finished products, obtained by pultrusion. The said sewn reinforcement is used in transverse reinforcement in addition to yarns at 0° provided conventionally by the pultrusion method. The pressures generated in the pultrusion die containing the high viscosity resin require retention of yarns in the transverse reinforcement in order to preserve the orientation of said yarns and therefore the transverse reinforcement of the profile or pre-impregnate,
principal reinforcing weave in a resin injection or infusion method.

Such a reinforcement has good mechanical strength at high temperature due to sewing with a yarn having sufficient strength during heating, as well as improvement in fraying and retention on preform because of the ability of the thermoplastic yarns forming the sewing yarn to ensure a certain locking of the yarns comprising the reinforcement.

1-12. (canceled)

13. A textile reinforcement suitable for use in a thermoplastic resin impregnation method, with a view to producing composite parts, comprising at least one set of high-tenacity yarns, each set comprising substantially parallel yarns, and a sewing yarn sewn through the at least one set to ensure the cohesion thereof, wherein the sewing yarn comprises a group of filaments having a melting temperature higher than the application temperature of the said thermoplastic impregnation resin, and a group of filaments produced from a thermoplastic material, miscible in the impregnation resin, and having a melting temperature lower than the application temperature of the said thermoplastic impregnation resin, the two groups of filaments being assembled by twisting or wrapping.

14. The reinforcement according to claim 13, wherein the set of yarns is a ply without crimping.

15. The reinforcement according to claim 13, wherein the reinforcement comprises two sets of yarns that are woven together.

16. The reinforcement according to claim 13, wherein the reinforcement comprises a single layer formed by a set of substantially parallel high-tenacity yarns, and a support layer formed by a fibrous material the fibers of which are not parallel to said layer of high-tenacity yarns.

17. The reinforcement according to claim 16, wherein the support layer is formed by a non-woven fabric.

18. The reinforcement according to claim 16, wherein the support layer is formed by a set of parallel yarns spaced apart from each other.

19. The reinforcement according to claim 13, wherein the reinforcement comprises at least two distinct groups of filaments produced from a thermoplastic material, miscible in the impregnation resin, and having a melting temperature lower than the application temperature of the said thermoplastic impregnation resin, each group of filaments being wrapped around the first group of filaments having a melting temperature greater than the application temperature of the said thermoplastic impregnation resin, and two of the said groups of filaments being wrapped in opposite directions.

20. The reinforcement according to claim 19, wherein the distinct groups of filaments are produced from a thermoplastic material, miscible in the impregnation resin, and have different melting temperatures.

21. The reinforcement according to claim 13, wherein the filaments having a melting temperature higher than the melting temperature of the thermoplastic impregnation resin are made of a material chosen from the group preferably comprising glass, cotton, aramid, liquid crystal polymers, carbon, quartz, basalt.

22. The reinforcement according to claim 13, wherein the filaments produced from a thermoplastic material, miscible in the impregnation resin and having a melting temperature lower than the application temperature of the said thermoplastic impregnation resin, are produced from a material chosen from the group comprising polyamides, polyphenylene sulfide, acrylic resins, polyimides, polyesters, polyaryletherketones.

23. The reinforcement according to claim 13, wherein the filaments having a melting temperature higher than the melting temperature of the thermoplastic impregnation resin, have a melting temperature or glass transition temperature of more than 250° C.

24. The reinforcement according to claim 13, wherein the sewing yarn has a yarn count of between 20 and 300 dtex.
